(19) United States
(12) Patent Application Publication
(10) Pub. No.: US 2026/0066720 A1
(43) Pub. Date: Mar. 5, 2026

(54) AXIAL FLUX JOINT MOTOR SYSTEM WITH INTEGRATED OIL INJECTION MICROCIRCULATION COOLING

(71) Applicant: Anhui University, Hefei (CN)

(72) Inventors: Qixu CHEN, Hefei (CN); Qunjing WANG, Hefei (CN); Guoli LI, Hefei (CN); Zhe QIAN, Hefei (CN); Qian ZHANG, Hefei (CN); Zehui SUN, Hefei (CN); Wenzhe DENG, Hefei (CN)

(73) Assignee: Anhui University, Hefei, AH (CN)

(21) Appl. No.: 19/302,113

(22) Filed: Aug. 18, 2025

(30) Foreign Application Priority Data
Aug. 28, 2024 (CN) 202411192001.0

(51) Int. Cl. H02K 1/20; H02K 1/18; H02K 7/116

(52) U.S. Cl. CPC H02K 1/20; H02K 1/182; H02K 7/116

(57) ABSTRACT

An axial-flux joint motor module includes an axial flux joint motor and a two-stage planetary reducer non-driving-end. The axial flux joint motor includes a non-driving-end stator, a driving-end stator, and a rotor; the non-driving-end stator and the driving-end stator are fixed together; the axial flux joint motor adopts direct oil injection cooling for the stator winding and combined oil cooling with the stator core; the non-driving-end stator and the driving-end stator share a common oil inlet channel and oil outlet; the non-driving-end stator includes a non-driving-end cover, and the driving-end stator includes a driving-end cover; This axial-flux joint motor module reduces the number of external oil pipeline pipes and joints, simplifies the complexity of the end cover oil passage, and improves the heat dissipation efficiency of the joint motor.

### FIELD

The invention is related to the field of motors, and particularly relates to an axial flux joint motor system integrating fuel injection micro-circulation cooling.

### BACKGROUND

This technology is applied in scenarios where joint motors for robot dogs and humanoid robots have high torque density requirements and low rotational speeds. Most of these motors adopt external rotor frameless torque motors, while a small number use axial flux motors. Torque amplification is achieved through single-stage or multi-stage planetary reducers, worm gear reducers, RV reducers, cycloidal pinwheel reducers, or harmonic reducers. In most application scenarios of joint motors, natural cooling schemes are commonly adopted, while air cooling or oil cooling schemes are rarely used. However, with the increasing number of joint motors in humanoid robots and the further enhancement of torque density requirements, there is an urgent need to improve the cooling capacity on the motor side.

### SUMMARY

To solve the above technical problems, the objective of the invention is to provide an axial flux joint motor system integrated with fuel injection micro-circulation cooling.

This system integrates the joint motor, the two-stage planetary reducer, the encoder, and the controller. Additionally, a fuel injection micro-circulation cooling scheme is introduced into the two stators of the joint motor. The humanoid robot adopts this fuel injection micro-circulation cooling method, similar to human blood circulation, which enhances the heat exchange efficiency of the motor and the controller, and meets the IP68 protection level requirements.

To achieve the above objectives, the technical solution adopted by the present invention is as follows:

An axial flux joint motor system, wherein the axial flux joint motor system comprises an axial flux joint motor and a two-stage planetary reducer; the axial flux joint motor includes a non-driving-end stator, a driving-end stator, and a rotor; the non-driving-end stator and the driving-end stator are fixed together; the axial flux joint motor adopts a combination of direct oil injection cooling for the stator winding and circulating oil cooling for the stator core; the non-driving-end stator and the driving-end stator share a common oil inlet channel and oil outlet; the non-driving-end stator includes a non-driving-end cover, and the driving-end stator includes a driving-end cover.

Preferably, the inner surface of the non-driving-end cover has a first spiral-shaped oil passage. The first spiral-shaped oil passage is a single spiral. The outermost circle of the first spiral-shaped oil passage is covered by a first oil thrower. The first oil thrower is provided with multiple first oil injection holes spaced circumferentially, which are used to spray the outer end of the stator winding. The innermost circle of the first spiral-shaped oil passage is covered by a second oil thrower, and the second oil thrower is provided with multiple second oil injection holes spaced circumferentially, which are used to spray the inner end of the stator winding. The middle spiral oil passage of the first spiral-shaped oil passage cools the stator core.

Preferably, the inner surface of the inner cavity of the drive end cover is provided with a second spiral-shaped oil passage, which is a single spiral. The outermost circle of the second spiral-shaped oil passage is covered by a third oil thrower; the third oil thrower is provided with multiple spaced third oil injection holes along the circumferential direction, which are used for injecting oil at the outer end of the stator winding; the innermost circle of the second spiral-shaped oil passage is covered by a fourth oil thrower, and the fourth oil thrower is provided with multiple spaced fourth oil injection holes along the circumferential direction, which are used for injecting oil at the inner end of the stator winding; the middle spiral oil passage of the second spiral-shaped oil passage cools the stator core.

The invention has the following beneficial effects:

The axial flux joint motor in this invention adopts a dual-stator/single-rotor topology. Each stator has a set of winding end ports for oil injection and a stator core circulation cooling subsystem. The two subsystems share one inlet channel and one outlet channel. Most of the cooling oil flows along the inner wall of the end cover to the oil outlet, and a small portion enters the air gaps on both sides of the rotor to cool the magnetic steel. This design reduces the number of external oil pipeline pipes and joints, and the single spiral channel of the end cover reduces the complexity of the end cover oil passage, thereby improving the heat dissipation efficiency of the joint motor.

### BRIEF DESCRIPTION OF THE DRAWINGS

FIG. 1 shows the overall exploded view of the axial flux joint motor system with integrated fuel injection and micro-circulation cooling in accordance with the present invention. This integrated fuel injection and micro-circulation cooling axial flux joint motor system comprises an axial flux joint motor and a two-stage planetary reducer.

FIG. 2a is the exploded view of the axial flux joint motor in FIG. 1;

FIG. 2b is the exploded view of the axial flux joint motor in FIG. 2a;

FIG. 3 is the exploded view of the two-stage planetary reducer in FIG. 1;

FIG. 4 is the exploded view of the stator at the non-driving end;

FIG. 5 is the stator at the driving end;

FIG. 6 is the end cover structure of the non-driving end;

FIG. 7 is the end cover structure of the driving end;

FIG. 8 is the sectional view of the oil circuit distribution of the axial flux joint motor;

FIG. 9 is the rotor structure with an aviation turbine of another embodiment.

### REFERENCE SIGNS

1, axial flux joint motor; 2, two-stage planetary reducer;
100, non-driving-end stator; 101, non-driving-end cover; 101a, cooling fins at the non-driving-end; 101b, first spiral oil passage; 101c, first oil inlet; 101d, oil outlet; 101e, non-driving-end boss; 101f, non-driving-end groove; 101h, first inclined section; 102, non-driving-end stator winding; 103, the non-driving-end stator core; 104, non-driving-end slot wedge; 105, first oil thrower; 105a, first oil spray hole; 106, second oil thrower; 106a, second oil spray hole; 107, non-driving-end baffle; 108, first screw; 109, second screw; 110, third screw; 111, fourth screw; 112, fifth screw.
200, driving-end stator; 201, end cover of the driving end; 201a, heat dissipation fins of the driving end; 201b, second spiral oil passage; 201c, second oil inlet; 201e, driving end boss; 201f, driving end groove; 201h, second inclined section; 202, stator winding of the driving end; 203, driving end stator core; 204, driving end slot wedge; 205, third oil thrower; 205a, third oil spray hole; 206, fourth oil thrower; 206a, fourth oil spray hole; 207, driving end baffle; 208, sixth screw; 209, seventh screw; 210, eighth screw; 211, ninth screw.
300, rotor; 301a, first rotor support; 301b, second rotor support; 302, rotor back iron; 303a, first magnet; 303b, second magnet; 304, tenth screw; 305, eleventh screw; 306a, first deep groove ball bearing; 306b, second deep groove ball bearing; 307a, first frame seal; 307b, second frame seal; 308, main shaft.
400a, first-stage planetary reducer; 400b, second-stage planetary reducer; 401, casing; 401a, bearing seat; 401b, second fin; 402, third deep groove ball bearing; 403, first circlips for holes; 404, cross roller bearing; 405, frame oil seal; 406, second circlips for holes; 407, planetary reducer end cover; 408, twelfth screw.

### DESCRIPTION OF THE EMBODIMENTS

To better clarify the objectives, technical solutions and advantages of the invention, the invention is described in further detail below in conjunction with accompanying drawings and examples. It should be understood that the specific examples described here are merely used for explaining invention and should not be construed as limitations of the invention. In addition, the technical features involved in the embodiments of the invention described below may be combined without conflicts.

The invention is described in detail below in conjunction with accompanying drawings.

The objective of the invention is to provide an axial-flux joint motor module adopting oil injection microcirculation cooling to satisfy heat-dissipation requirements under a high-torque load condition.

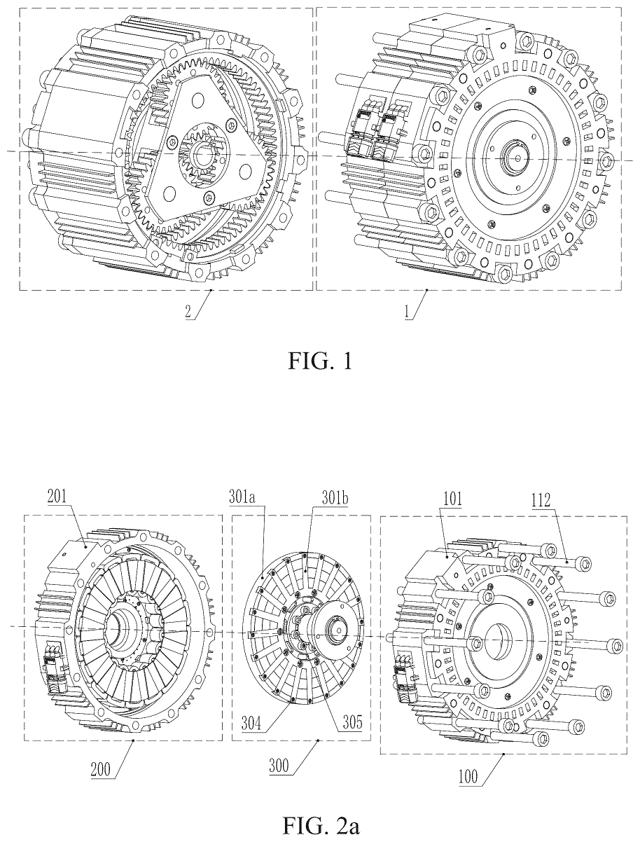

As shown in FIG. 1 to FIG. 8, this is a kind of axial flux joint motor system with integrated fuel injection micro-circulation cooling, including an axial flux joint motor 1 and a two-stage planetary reducer 2. The axial flux joint motor 1 consists of a non-driving-end stator 100, a driving-end stator 200 and a rotor 300; the two-stage planetary reducer 2 includes a first-stage planetary reducer 400a and a second-stage planetary reducer 400b. The output shaft of the axial flux joint motor 1 is connected to the sun wheel of the first-stage planetary reducer 400a of the two-stage planetary reducer 2, and the planetary carrier flange of the second-stage planetary reducer 400b serves as the output shaft of the joint motor.

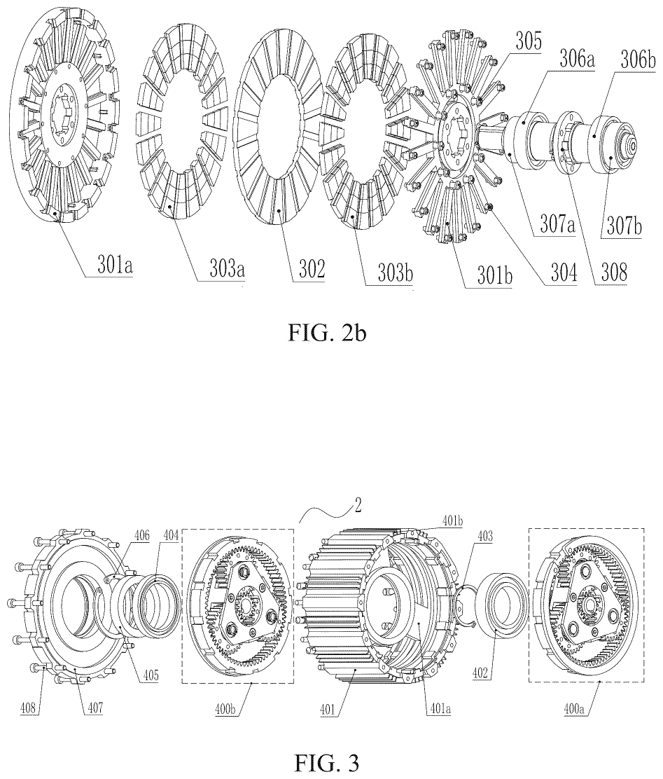

As shown in FIG. 1, FIG. 2a and FIG. 2b, the non-driving-end stator 100 and the driving-end stator 200 are fixed to each other. Specifically, the non-driving-end stator 100 and the driving-end stator 200 are fixed together by the fifth screw 112. In this embodiment, the rotor 300 is sequentially composed of the first rotor support 301a, the first magnet 303a, the rotor back yoke 302, the second magnet 303b and the second rotor support 301b. The first rotor support 301a and the second rotor support 301b compress and fix the first magnet 303a, the rotor back yoke 302 and the second magnet 303b. Among them, the first magnet 303a is sandwiched between the first rotor support 301a and the rotor back yoke 302; the second magnet 303b is sandwiched between the rotor back iron 302 and the second rotor support 301b. In this embodiment, the first rotor support 301a and the second rotor support 301b are fixed by the tenth screw 304 and the eleventh screw 305. In this embodiment, the first magnet 303a and the second magnet 303b are both surface-mounted magnets. The rotor 300 also includes a main shaft 308, and first and second deep groove ball bearings 306a and 306b respectively located at both ends of the main shaft 308. The first and second deep groove ball bearings 306a and 306b provide rotational support for the rotor 300. The rotor 300 also includes a first frame seal 307a on the outer side of the first deep groove ball bearing 306a and a second frame seal 307b on the outer side of the second deep groove ball bearing 306b, to achieve sealing effect.

As shown in FIG. 3, the two-stage planetary reducer 2 includes a shell 401, a first-stage planetary reducer 400a and a second-stage planetary reducer 400b. The shell 401 is internally designed with a bearing seat 401a, which is used to support the third deep groove ball bearing 402 and is limited by a first circlips for holes 403; the outer circular periphery of theshell 401 is designed with a second fin 401b, which is used to increase the heat dissipation of the two-stage planetary reducer 2. The planet carrier flange shaft of the second-stage planetary reducer 400b is installed in the cavity of the cross roller bearing 404, and the cross roller bearing 404 is successively installed with a frame oil seal 405 and a second circlips for holes 406 on its outer side. The frame oil seal 405 is used to seal the two-stage planetary reducer 2, and the second circlips for holes 406 is used to limit the axial movement of the cross roller bearing 404. The cross roller bearing 404, the frame oil seal 405 and the second circlips for holes 406 are installed on the inner circular surface of the planetary reducer end cover 407, and the planetary reducer end cover 407 is fixed to the shell 401 using the twelfth screw 408.

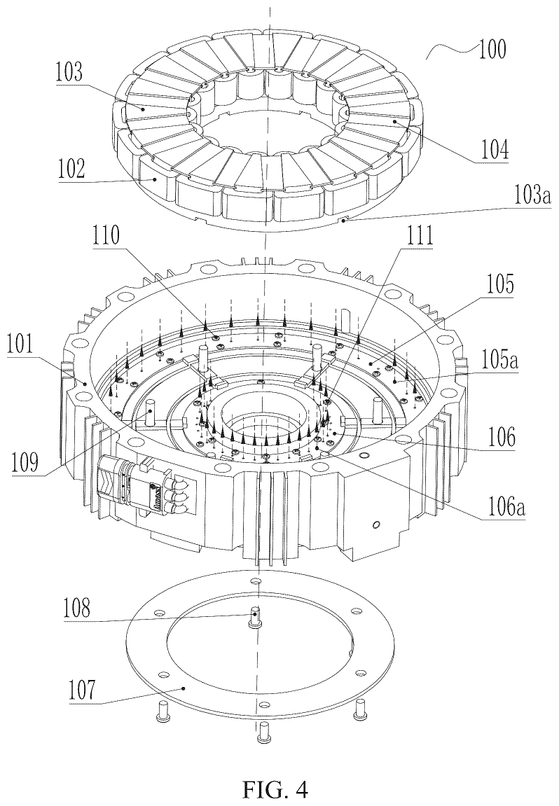

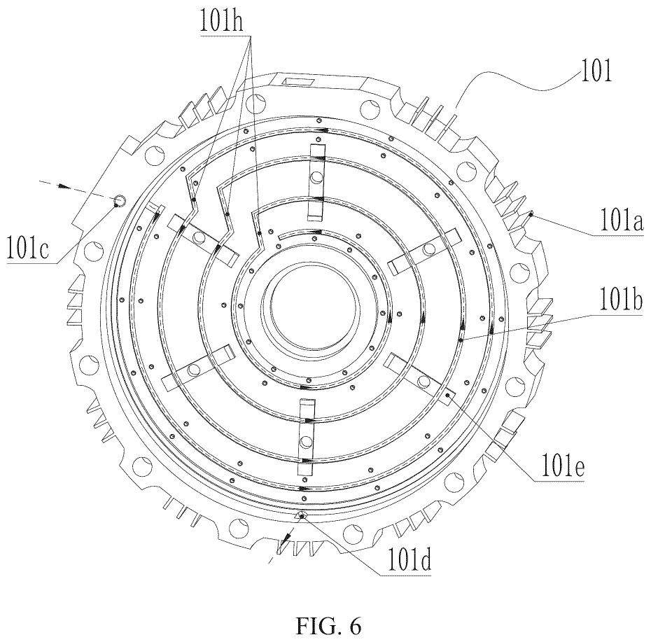

As shown in FIG. 4 and FIG. 6, the non-driving-end stator 100 includes the non-driving-end cover 101, the non-driving-end stator core 103, and the non-driving-end stator winding 102. The non-driving-end stator winding 102 is embedded in the stator teeth of the non-driving-end stator core 103 and is clamped by the non-driving-end spacer 104.

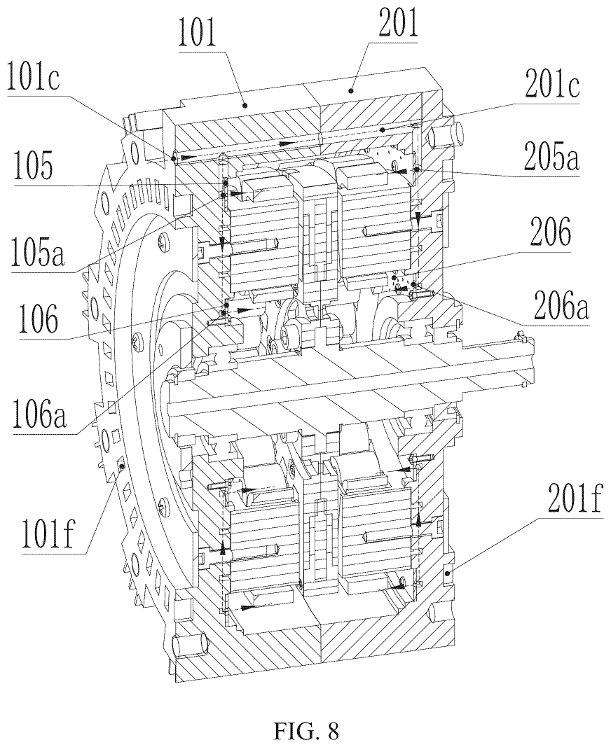

The inner end face of the non-driving-end cover 101 has the non-driving-end boss 101e. The bottom of the non-driving-end stator core 103 has a groove 130a. The non-driving-end boss 101e is assembled with the groove 103a of the non-driving-end stator core 103 to restrict the rotational movement of the non-driving-end stator core 103. The non-driving-end stator core 103 is fixed to the non-driving-end cover 101 by the second screw 109. The non-driving-end baffle 107 is installed on the outer end face of the non-driving-end cover 101 and is fixed to the non-driving-end cover 101 by the first screw 108. The side end face of the non-driving-end cover 101 is designed with the non-driving-end groove 101f (as shown in FIG. 8), which performs a part of the heat dissipation function.

The outer circular surface of the non-driving-end cover 101 extends with non-driving-end heat dissipation fins 101a. The non-driving-end cover 101 is provided with a first oil passage inlet 101c. The internal cavity end face of the non-driving-end cover 101 is designed with a first spiral oil passage 101b, and the first spiral oil passage 101b is connected with the first oil passage inlet 101c. Specifically, the first spiral oil passage 101b includes multiple arcs of unequal diameters and multiple first inclined sections 101h, and each first inclined section 101h is connected to adjacent arcs.

The outermost circle of the first spiral oil passage 101b is covered by a first oil thrower 105; the first oil thrower 105 is fixed to the non-driving-end cover 101 by a third screw 110. The first oil thrower 105 has multiple first oil spray holes 105a spaced circumferentially; the multiple first oil spray holes 105a align with and are connected to the outermost circle of the first spiral oil passage 101b. The innermost circle of the first spiral oil passage 101b is covered by a second oil thrower 106, and the second oil thrower 106 is fixed to the non-driving-end cover 101 by a fourth screw 111. The second oil thrower 106 has multiple second oil spray holes 106a spaced circumferentially; the multiple second oil spray holes 106a align with and are connected to the innermost circle of the first spiral oil passage 101b.

As shown in FIGS. 4 and 6, the oil flow direction at the non-driving end is: the first oil inlet 101c→the outermost circle of the first spiral oil passage 101b→the first fuel injection hole 105a for fuel injection→the middle spiral oil passage of the first spiral oil passage 101b→the innermost circle of the first spiral oil passage 101b→the second fuel injection hole 106a for fuel injection→the oil outlet 101d flows out.

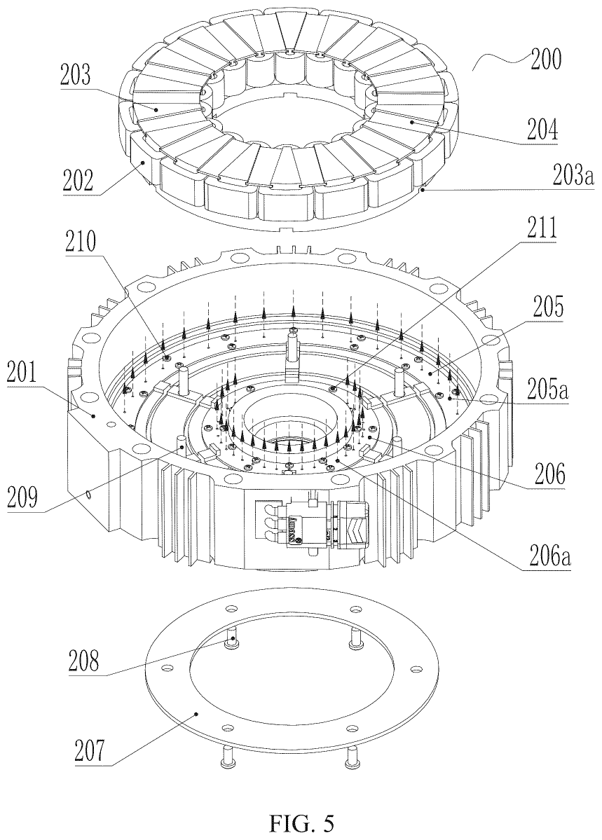

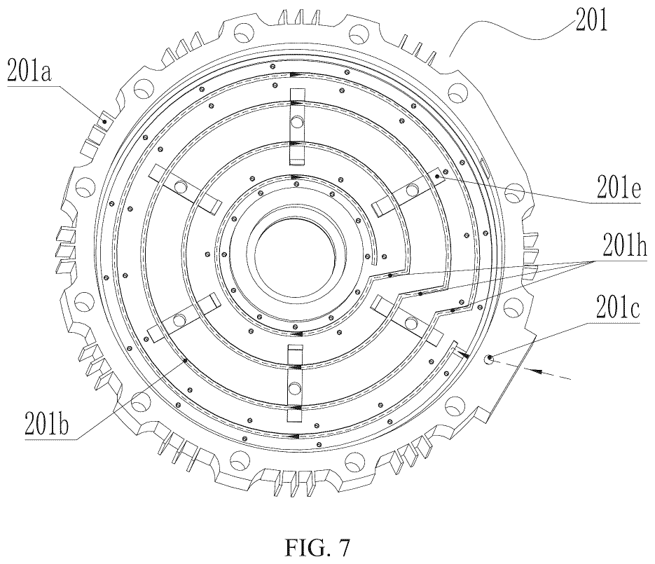

As shown in FIG. 5, FIG. 7, and FIG. 8, the stator at the driving end 200 includes the driving end cover 201, the driving end stator core 203, and the driving end stator winding 202. The driving end stator winding 202 is embedded in the stator teeth of the driving end stator core 203 and is pressed by the driving end slot wedge 204.

The inner end face of the drive end cover 201 has a drive end boss 201e. The bottom of the drive end stator core 203 is provided with a groove 203a. The drive end boss 201e is assembled with the groove 203a of the drive end stator core 203 to restrict the rotational movement of the drive end stator core 203. The drive end stator core 203 is fixed to the drive end cover 201 by the seventh screw 209. The drive end baffle 207 is installed on the outer end face of the drive end cover 201 and is fixed to the drive end cover 201 by the sixth screw 208. The side end face of the drive end cover 201 is designed with a drive end groove 201f (as shown in FIG. 8), which performs part of the heat dissipation function.

The outer circular surface of the drive end cover 201 extends with drive end heat dissipation fins 201a. The drive end cover 201 has a second oil inlet 201c. The internal cavity end face of the drive end cover 201 is designed with a second spiral-shaped oil passage 201b, which is connected to the second oil inlet 201c. Specifically, the second spiral-shaped oil passage 201b includes multiple arcs of unequal diameters and multiple second inclined sections 201h, and each second inclined section 201h is connected to adjacent arcs.

The outermost ring of the second helical oil passage 201b is covered by a third oil thrower 205; the third oil thrower 205 is fixed to the drive end cover 201 by the eighth screw 210. The third oil thrower 205 has multiple spaced third oil injection holes 205a along the circumferential direction; these multiple third oil injection holes 205a align with and are connected to the outermost ring of the second helical oil passage 201b. The innermost ring of the second helical oil passage 201b is covered by a fourth oil thrower 206, which is fixed to the drive end cover 201 by the ninth screw 211. The fourth oil thrower 206 has multiple spaced fourth oil injection holes 206a along the circumferential direction; these multiple fourth oil injection holes 206a align with and are connected to the innermost ring of the second helical oil passage 201b.

As shown in FIG. 5 and FIG. 7, the oil flow direction of the drive end: the second oil passage inlet 201c→the outermost ring of the second helical oil passage 201→oil injection through the third oil injection hole 205a→the middle helical oil passage of the second helical oil passage 201b→the innermost ring of the second helical oil passage 201b→oil injection through the fourth oil injection hole 206a→oil flows out through the oil outlet 101d.

The branch circuit of the driving-end stator 200 is the same as that of the non-driving end stator 100 oil circuit. Taking the oil circuit branch of the non-driving end stator 100 as an example: The first fuel injection hole 105a injects fuel to cool the outer end winding of the non-driving end stator winding 102; the second fuel injection hole 106a injects fuel to cool the inner end winding of the non-driving end stator winding 102; the middle spiral oil passage 101b of the first spiral oil passage 101b cools the non-driving end stator core 103.

As shown in FIG. 6 and FIG. 8, the pump sucks oil from the oil tank→the inlet of the oil intake channel is divided into two parallel branches: the first oil passage inlet 101c and the second oil passage inlet 201c. The oil intake channels of the non-driving end cover 101 and the driving end cover 201 are connected, and have a common oil outlet 101d.

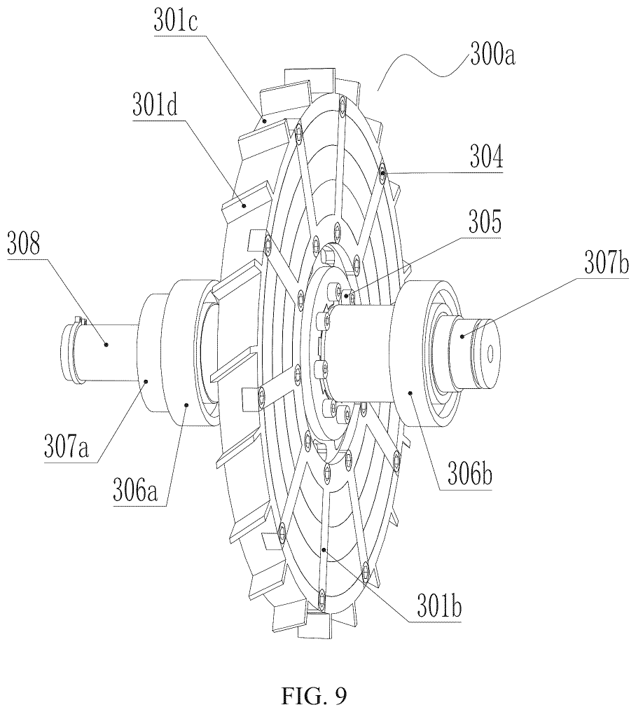

As shown in FIG. 9, in another embodiment, the rotor 300a includes a first rotor support 301c and a second rotor support 301b. The first rotor support 301c and the second rotor support 301b are fixed together by the tenth screw 304 and the eleventh screw 305. The rotor 300a also includes a main shaft 308, a first deep groove ball bearing 306a, a second deep groove ball bearing 306b, a first shell seal 307a and a second shell seal 307b. The difference lies in that the first rotor support 301c includes turbine fins 301d arranged at the periphery.

Those skilled in the art may easily understand that the above embodiments are merely preferred ones of the invention and are not intended to limit the invention. Any modifications, equivalent substitutions and improvements made based on the spirit and principle of the invention should also fall within the protection scope of the invention.

Those skilled in the art may easily understand that the above embodiments are merely preferred ones of the invention and are not intended to limit the invention. Any modifications, equivalent substitutions and improvements made based on the spirit and principle of the invention should also fall within the protection scope of the invention.

What is claimed is:

1. An axial-flux joint motor module, comprising an axial flux joint motor and a two-stage planetary reducer;
wherein the axial flux joint motor includes a non-driving-end stator, a driving-end stator, and a rotor; the non-driving-end stator and the driving-end stator are fixed together; the axial flux joint motor adopts direct oil injection cooling for the stator winding and combined oil cooling with the stator core; the non-driving-end stator and the driving-end stator share a common oil inlet channel and oil outlet; the non-driving-end stator includes a non-driving-end cover, and the driving-end stator includes a driving-end cover;
the inner surface of the inner cavity of the non-driving end cover is provided with a first spiral-shaped oil passage, which is a single spiral ; the outermost circle of the first spiral-shaped oil passage is covered by a first oil thrower; the first oil thrower is provided with multiple first oil injection holes spaced circumferentially, which are used to spray the outer end of the stator winding; the innermost circle of the first spiral-shaped oil passage is covered by a second oil thrower, and the second oil thrower is provided with multiple second oil injection holes spaced circumferentially, which are used to spray the inner end of the stator winding; the middle spiral oil passage of the first spiral-shaped oil passage cools the stator core; and
the inner surface of the inner cavity of the drive end cover is provided with a second spiral-shaped oil passage, which is a single spiral; the outermost circle of the second spiral-shaped oil passage is covered by a third oil thrower; the third oil thrower is provided with multiple spaced third oil injection holes along the circumferential direction, which are used for injecting oil at the outer end of the stator winding; the innermost circle of the second spiral-shaped oil passage is covered by a fourth oil thrower, and the fourth oil thrower is provided with multiple spaced fourth oil injection holes along the circumferential direction, which are used for injecting oil at the inner end of the stator winding; the middle spiral oil passage of the second spiral-shaped oil passage cools the stator core.

2. The axial-flux joint motor module according to claim 1, wherein the outer circular periphery of the non-driving-end cover is designed with heat dissipation fins.

3. The axial-flux joint motor module according to claim 2, wherein the outer circular periphery of the driving-end cover is designed with heat dissipation fins.

4. The axial-flux joint motor module according to claim 3, wherein the non-driving-end stator and the driving-end stator are mutually fixed; a first oil inlet is provided on the non-driving-end cover, and a second oil inlet is provided on the driving-end cover; when the pump sucks oil from the oil tank and enters the oil inlet channel, it splits into two parallel branches, entering through the first oil inlet and the second oil inlet respectively; the oil inlet channels of the non-driving-end cover and the driving-end cover are connected and share a common oil inlet channel; the oil flow direction of the non-driving-end stator is as follows: oil is injected from the first oil inlet, passes through the non-driving-end stator, then through the outermost circle of the first spiral oil passage, is sprayed through the first spray hole, then enters the middle spiral oil passage of the first spiral oil passage, and finally enters the innermost circle of the first spiral oil passage through the second spray hole, and then flows out through the oil outlet.

5. The axial-flux joint motor module according to claim 4, wherein the oil flow direction of the driving-end stator is: oil is injected from the second oil inlet, passes through the driving-end stator, then passes through the outermost layer of the second spiral oil passage and is injected through the third oil injection hole, then flows through the middle spiral oil passage of the second spiral oil passage, and finally flows through the innermost layer of the second spiral oil passage and is injected through the fourth oil injection hole, and then flows out from the oil outlet.

6. The axial-flux joint motor module according to claim 1, wherein the outer circular surface of the shell of the two-stage planetary reducer is provided with heat dissipation fins; the output flange of the planetary gear of the two-stage planetary reducer is supported by a cross roller bearing; the input end cover of the two-stage planetary reducer and the end cover of the magnetic flux joint motor drive end share one end cover; the outer end face of the end cover is provided with a groove along the circumference, and the outer circular surface is also provided with heat dissipation fins; the output shaft of the axial flux joint motor is connected to the sun wheel of the first stage of the two-stage planetary reducer; the second-stage planetary gear flange serves as the output shaft of the axial flux joint motor; the controller is placed on the axial flux non-drive end surface of the joint motor and shares the cooling end cover with the non-drive end stator.

7. The axial-flux joint motor module according to claim 1, wherein the joint motor system also integrates an encoder and a controller.

8. The axial-flux joint motor module according to the axial flux joint motor system as described in claim 1, wherein the first spiral-shaped oil passage comprises multiple arc segments of unequal diameters and multiple first inclined segments; each of the first inclined segments is connected to the adjacent arc segments of the first spiral-shaped oil passage.

9. The axial-flux joint motor module according to claim 1, wherein the second spiral-shaped oil passage comprises multiple arc segments of unequal diameters and multiple second inclined segments; and each of the second inclined segments is connected to the adjacent arc segments of the second spiral-shaped oil passage.

10. The axial-flux joint motor module according to the axial flux joint motor system as described in claim 1, wherein the first oil thrower, the second oil thrower and the inner surface of the cavity of the non-driving-end cover are fixed; the third oil thrower and the fourth oil thrower are fixed to the inner surface of the cavity of the driving-end cover.
